(19) United States
(12) Patent Application Publication
(10) Pub. No.: US 2013/0013902 A1
(43) Pub. Date: Jan. 10, 2013

(54) DYNAMICALLY RECONFIGURABLE PROCESSOR AND METHOD OF OPERATING THE SAME

(75) Inventors: Toshio Isomura, Komaki-shi (JP); Masumi Dakemoto, Nagoya-shi (JP)

(73) Assignee: Toyota Jidosha Kabushiki Kaisha, Toyota-shi, Aichi (JP)

(21) Appl. No.: 13/635,307

(22) PCT Filed: Apr. 6, 2010
(86) PCT No.: PCT/JP2010/056227

§ 371 Date: Sep. 14, 2012

(51) Int. Cl. G06F 9/30

(52) U.S. Cl. 712/226; 712/E09.016

(57) ABSTRACT

A dynamically reconfigurable processor which executes a series of processes on an instruction basis for respective instructions, comprises: a dynamically configurable computing unit; and a clock generating circuit, wherein start timing for processes in the series of processes is determined based on the main clock except for an instruction execution process of executing the instruction with the dynamically configurable computing unit, the instruction execution process of executing the instruction with the dynamically configurable computing unit includes a computing element generating sub-process of dynamically configuring, with dynamically configurable computing unit, a computing element corresponding to the instruction, and an operation sub-process of performing an operation according to the instruction with the computing element configured in the computing element generating sub-process, start timing for the computing element generating sub-process and the operation sub-process is determined based on the sub-clock, and the sub-clock is generated such that the computing element generating sub-process and the operation sub-process are completed before the start timing for a process which is to be executed immediately after the instruction execution process.

### TECHNICAL FIELD

The present invention is related to a dynamically reconfigurable processor which executes a series of processes on an instruction basis for respective instructions, and a method of operating the same.

### BACKGROUND ART

An arithmetic processor known from Patent Document 1 includes a rewritable memory (RAM) in which computing element configuration information is stored, and a special-purpose computing unit which configures predetermined computing elements based on the computing element configuration information in the memory. The predetermined computing elements are configured by a FPGA (Field Programmable Gate Array).

[Patent Document 1] Japanese Laid-open Patent Publication No. 07-175631

### DISCLOSURE OF INVENTION

### Problem to be Solved by Invention

According to a RISC (Reduced Instruction Set Computer) processor or the like, a process is performed with a cycle of Fetch (IF), Decode (ID), Execute (EX), Data Cache (DC) and Write Back (WB), and Execute is performed using computing elements which are prepared as hardware resources of a CPU in advance on an instruction basis. Further, for the purpose of high-speed processing, a pipeline process is performed.

However, according to a solution in which computing elements are prepared as hardware resources on an instruction basis, there is a problem that an area occupied by the hardware resources is increased. For example, representative instructions include a load/store instruction, an integer arithmetical operation/logic operation instruction, a branch instruction, a bit manipulation instruction, etc. Each of these instructions includes few or tens of instruction types, and there may be a case where instructions corresponding to the number of operands and instructions according to word lengths are prepared. Thus, there may be even hundreds of the instructions in the case of 32-bit microcomputers.

Computing units (hardware resources) have to be prepared in advance in the CPU on an instruction basis; however, in fact, only one computing element is operated and other computing elements are disabled at a certain time.

In this connection, according to the solution disclosed in Patent Document 1, since the predetermined computing elements can be configured by the FPGA, the number of computing elements to be prepared in a fundamental computing unit can be reduced, leading to increased speed of the operation and miniaturization of a device.

However, in the solution in which the computing element is dynamically configured by the FPGA according to the instruction, in order to execute the instruction without delay, it is necessary to complete a process of dynamically configuring the computing element according to the instruction with the FPGA and a process of performing an operation with the configured computing element before the clock timing of the data cache.

Therefore, an object of the present invention is to provide a dynamically reconfigurable processor and a method of operating the same which may complete a process of dynamically configuring a computing element according to an instruction and a process of performing an operation with the configured computing element without delay.

### Means to Solve the Problem

In order to achieve the object, according to one aspect of the invention, a dynamically reconfigurable processor which executes a series of processes on an instruction basis for respective instructions is provided, which includes

a dynamically configurable computing unit which dynamically configures a computing element according to the instruction; and

a clock generating circuit configured to generate a main clock and a sub-clock which is different from the main clock, wherein

start timing for the processes in the series of processes is determined based on the main clock except for an instruction execution process of executing the instruction with the dynamically configurable computing unit,

the instruction execution process of executing the instruction with the dynamically configurable computing unit includes a computing element generating sub-process of dynamically configuring, with the dynamically configurable computing unit, the computing element corresponding to the instruction, and an operation sub-process of performing an operation according to the instruction with the computing element configured in the computing element generating sub-process,

start timing for the computing element generating sub-process and the operation sub-process is determined based on the sub-clock , and

the sub-clock is generated such that the computing element generating sub-process and the operation sub-process are completed before the start timing for a process which is to be executed immediately after the instruction execution process.

According to one aspect of the invention, a method of operating a processor is provided which includes:

a fetch process of retrieving an instruction;

a decode process of decoding the retrieved instruction;

an execute process; and

a data cache process, wherein

the execute process includes a computing element generating sub-process of dynamically configuring a computing element corresponding to the instruction, and an operation sub-process of performing an operation according to the instruction with the computing element configured in the computing element generating sub-process,

in said method,

the fetch process is performed at a first timing which is determined by a main clock,

the decode process is performed at a second timing which is determined by the main clock,

the computing element generating sub-process is performed at the first timing which is determined by a sub-clock, instead of a third timing which is determined by the main clock, and the operation sub-process is performed at the second timing which is determined by the sub-clock, and

the data cache process is performed at a fourth timing which is determined by the main clock.

### Advantage of the Invention

According to the present invention, a dynamically reconfigurable processor and a method of operating the same which may complete a process of dynamically configuring a computing element according to an instruction and a process of performing an operation with the configured computing element without delay can be obtained.

### BRIEF DESCRIPTION OF DRAWINGS

FIG. 1 is a diagram for schematically illustrating a configuration of a dynamically reconfigurable processor 1 according to a first embodiment of the present invention.

FIG. 2 is a diagram for illustrating an example of a way of setting a minimum set computing unit 11.

FIG. 3 is a diagram for illustrating another example of a way of setting a minimum set computing unit 11.

FIG. 4 is a diagram for illustrating yet another example of a way of setting a minimum set computing unit 11.

FIG. 5 is a diagram for illustrating an example of a time sequence in the case where a single-threaded operation (not pipelined) is implemented with a single minimum set computing unit 11 according to the embodiment.

FIG. 6 is a diagram for illustrating a transition of the minimum set computing unit 11 corresponding to FIG. 5.

FIG. 7 is a diagram for illustrating an example of a time sequence in the case where a multi-threaded operation (two-stage pipeline) is implemented with two minimum set computing units 11A and 11B according to the embodiment.

FIG. 8 is a diagram for illustrating a transition of computing elements configured by the minimum set computing units 11A and 11B corresponding to FIG. 7.

FIG. 9 is a diagram for illustrating an example of a time sequence in the case where a multi-threaded operation (five-stage pipeline) is implemented with two minimum set computing units 11A and 11B according to the embodiment.

FIG. 10 is a diagram for illustrating an example of a time sequence in the case where a superscalar architecture is implemented with two minimum set computing units 11A and 11B according to the embodiment.

FIG. 11 is a diagram for illustrating a transition of computing elements configured by the minimum set computing units 11A and 11B corresponding to FIG. 10.

FIG. 12 is a diagram for schematically illustrating a configuration of a dynamically reconfigurable processor 2 according to a second embodiment of the present invention.

FIG. 13 is a diagram for schematically illustrating a configuration of a dynamically reconfigurable processor 3 according to another embodiment (third embodiment) of the present invention.

FIG. 14 is a diagram for illustrating an example of a time sequence in the case where a single-threaded operation (not pipelined) is implemented with a CPU 22.

FIG. 15 is a diagram for illustrating an example of a time sequence in the case where a multi-threaded operation (two-stage pipeline) is implemented with a CPU 22.

FIG. 16 is a diagram for illustrating an example of a time sequence in the case where a superscalar architecture is implemented with a CPU 22.

FIG. 17 is a diagram for illustrating a situation in which the pipeline is stalled.

FIG. 18 is a diagram for illustrating an example of an application of the minimum set computing unit 11 for preventing a pipeline stall.

FIG. 19 is a diagram for illustrating an example of a configuration of a clock generating circuit 12 (first delay prevention method).

FIG. 20 is a diagram for illustrating a principle of a delay prevention function implemented by the clock generating circuit 12 illustrated in FIG. 19.

FIG. 21 is a diagram for illustrating a delay which occurs if only a clock CLK1 is used.

FIG. 22 is a diagram for illustrating another example of a configuration of a clock generating circuit 12 (second delay prevention method).

FIG. 23 is a diagram for illustrating a principal of a delay prevention function implemented by the clock generating circuit 12 illustrated in FIG. 22.

FIG. 24 is a diagram for illustrating a situation in which a delay cannot be completely prevented by the second delay prevention method alone.

FIG. 25 is a diagram for illustrating a principle of a delay prevention function implemented by a combination of the first delay prevention method and the second delay prevention method.

### DESCRIPTION OF REFERENCE SYMBOLS

1, 2, 3 dynamically reconfigurable processor
10 CPU
11 minimum set computing unit
12 clock generating circuit
13 oscillation circuit
14 oscillator
15 first clock multiplier circuit
17 second clock multiplier circuit
18 phase adjustment circuit
20 backup gate
22 CPU

### BEST MODE FOR CARRYING OUT THE INVENTION

In the following, the best mode for carrying out the present invention will be described in detail by referring to the accompanying drawings.

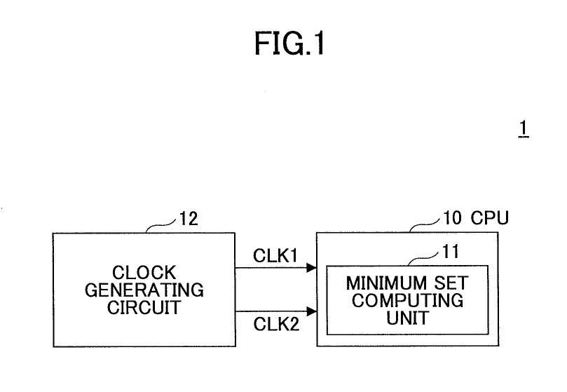

FIG. 1 is a diagram for schematically illustrating a configuration of a dynamically reconfigurable processor 1 according to an embodiment (a first embodiment) of the present invention.

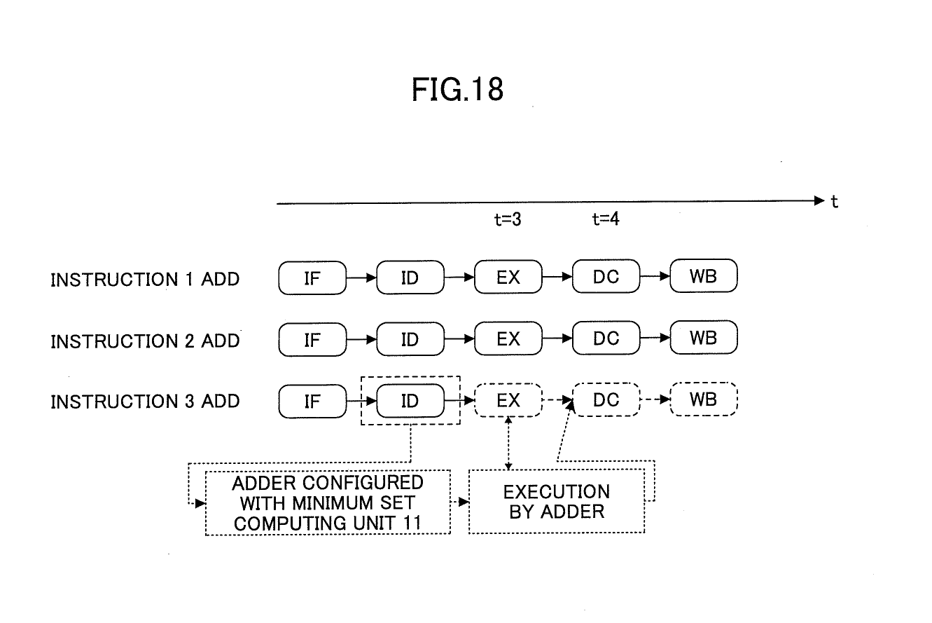

The dynamically reconfigurable processor 1 includes a CPU 10 and a clock generating circuit 12. The clock generating circuit 12 generates two clocks CLK1 and CLK2 which are necessary for operations of the CPU 10. The clock CLK1 is a main clock. The clock CLK2 is a special clock which is generated for preventing a delay as described hereinafter. A configuration of the clock generating circuit 12 and a function of the clock CLK2 are described hereinafter. It is noted that in, the following explanations before and including an explanation with reference to FIG. 18, the term “clock” indicates the main clock. An explanation after FIG. 18 is made using the separate terms “clocks CLK1 and CLK2”.

The CPU 10 includes a minimum set computing unit 11 which configures an instruction executing part (mainly an arithmetic circuit). The CPU 10 may include an ordinary configuration, except for the arithmetic circuit, which includes an instruction decoder control circuit, an instruction cache, a register file, a data cache, etc. (not illustrated). The CPU 10 is connected to memory (a ROM, a RAM, etc.).

The minimum set computing unit 11 includes minimum gates (or elements) which are capable of configuring possibly all computing elements corresponding to all the instruction sets. All the instruction sets may be all the instructions included in a software resource(s) installed in the dynamically reconfigurable processor 1, or may additionally include other instructions so as to have general versatility. The expression “capable of configuring” means “capable of configuring” in theory and does not necessitate “configure in fact”.

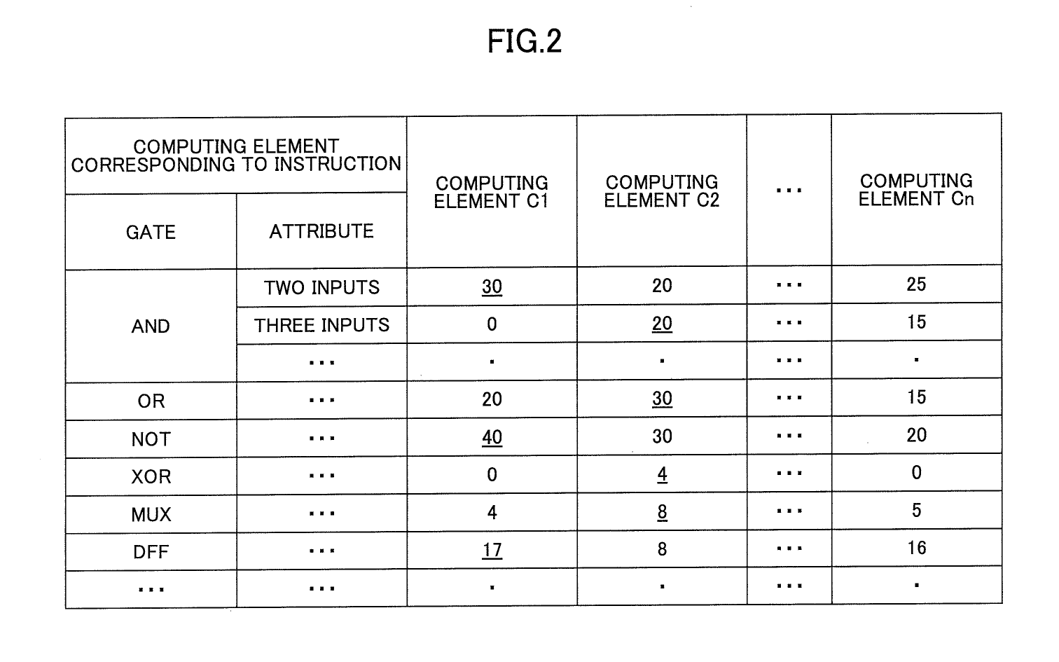

FIG. 2 is a diagram for illustrating an example of a way of setting a minimum set computing unit 11. In the example illustrated in FIG. 2, the minimum set computing unit 11 consists of a FPGA (Field Programmable Gate Array) which includes minimum gates which are capable of configuring possibly all computing elements corresponding to all the instruction sets. In other words, the minimum set computing unit 11 is configured to include minimum gates as a unit of a gate at gate level for so-called FPGA synthesis. The gates for FPGA synthesis include, in addition to gates for ASIC (application specific integrated circuit) logic synthesis such as NAND, NOR, NOT, complicated gates (which are configured by a combination of the gates for ASIC logic synthesis) such as AND, OR. For example, AND is a gate configured by a combination of NAND and NOT, and OR is a gate configured by a combination of NOR and NOT.

In FIG. 2, the respective computing elements corresponding to the respective instructions included in all the instruction sets are illustrated. For example, a computing element C1 is a computing element for executing an addition instruction without carry of 16 bits and it is meant that the computing element C1 is configured by 30 AND gates with two inputs, 20 OR gates, 40 NOT gates, 4 MUX gates, 17 DFF (D flip-flop), etc. Similarly, computing elements C2, . . . , Cn (n corresponding to the number of the computing elements corresponding to the respective instructions of all the instruction sets) are other computing elements corresponding to the respective instructions (except for the addition instruction related to the computing element C1) of all the instruction sets. It is noted that the numbers in the table illustrated in FIG. 2 are just examples and are not technically correct.

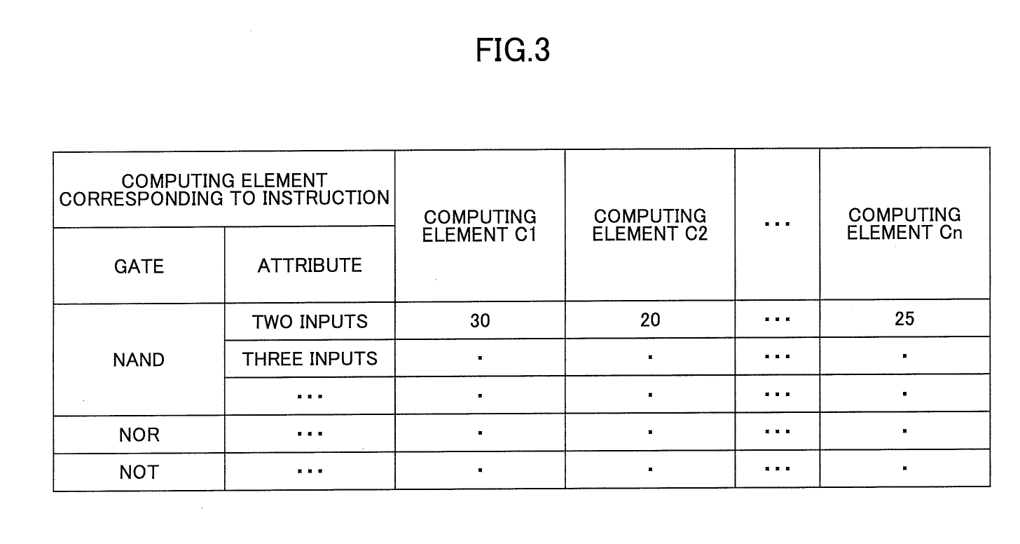

In the example illustrated in FIG. 2, in order to configure the minimum set computing unit 11, the minimum number of the gates required to be capable of configuring any one of the computing elements C1, . . . , Cn are prepared for the respective types of the gates such that the number of the AND gates with two inputs to be prepared is a maximum number (30 in this example) of the numbers (30, 20, . . . , 25, in this example) of the AND gates required to be capable of configuring all the computing elements C1, . . . , Cn corresponding to all the instruction sets, respectively; similarly, the number of the AND gates with three inputs to be prepared is a maximum number (20 in this example) of the numbers (0, 20, . . . , 15, in this example) of the AND gates required to be capable of configuring all the computing elements C1, . . . , Cn corresponding to all the instruction sets, respectively; similarly, the number of the OR gates to be prepared is a maximum number (30 in this example) of the numbers (20, 30, . . . , 15, in this example) of the OR gates required to be capable of configuring all the computing elements C1, . . . , Cn corresponding to all the instruction sets, respectively; similarly, the number of the NOT gates to be prepared is a maximum number (40 in this example) of the numbers (40, 30, . . . , 20, in this example) of the NOT gates required to be capable of configuring all the computing elements C1, . . . , Cn corresponding to all the instruction sets, respectively; similarly, the number of the XOR gates to be prepared is a maximum number (4 in this example) of the numbers (0, 4, . . . , 0, in this example) of the XOR gates required to be capable of configuring all the computing elements C1, . . . , Cn corresponding to all the instruction sets, respectively; similarly, the number of the MUX gates to be prepared is a maximum number (8 in this example) of the numbers (4, 8, . . . , 5, in this example) of the MUX gates required to be capable of configuring all the computing elements C1, . . . , Cn corresponding to all the instruction sets, respectively; similarly, the number of the DFF gates to be prepared is a maximum number (17 in this example) of the numbers (17, 8, . . . , 16, in this example) of the DFF gates required to be capable of configuring all the computing elements C1, . . . , Cn corresponding to all the instruction sets, respectively, and so on. FIG. 3 is a diagram for illustrating another example of a way of setting the minimum set computing unit 11. In the example illustrated in FIG. 3, the minimum set computing unit 11 is configured to include minimum gates as a unit of a gate which is smaller than a unit of a gate at the gate level for FPGA synthesis. Specifically, the minimum set computing unit 11 is configured to include minimum gates as a unit of a gate at gate level for so-called. ASIC logic synthesis. In other words, the minimum set computing unit 11 is configured to include minimum gates as a unit of a gate of NAND, NOR and NOT.

In FIG. 3, as is the case with FIG. 2, the respective computing elements corresponding to the respective instructions included in all the instruction sets are illustrated. The way of seeing the table illustrated in FIG. 3 is the same as that in FIG. 2. The numbers of the NAND gates, the NOR gates and the NOT gates are illustrated, respectively, for all the computing elements C1, . . . , Cn corresponding to all the instruction sets, respectively. It is noted that the numbers in the table illustrated in FIG. 3 are just examples and are not technically correct.

In the example illustrated in FIG. 3, as is the case with the example illustrated in FIG. 2, in order to configure the minimum set computing unit 11, the minimum number of the gates required to be capable of configuring any one of all the computing elements C1, . . . , Cn are prepared for the respective NAND gate, NOR gate and NOT gate such that the number of the NAND gates with two inputs to be prepared is a maximum number (30 in this example) of the numbers (30, 20, . . . , 25, in this example) of the NAND gates required to be capable of configuring all the computing elements C1, . . . , Cn corresponding to all the instruction sets, and so on.

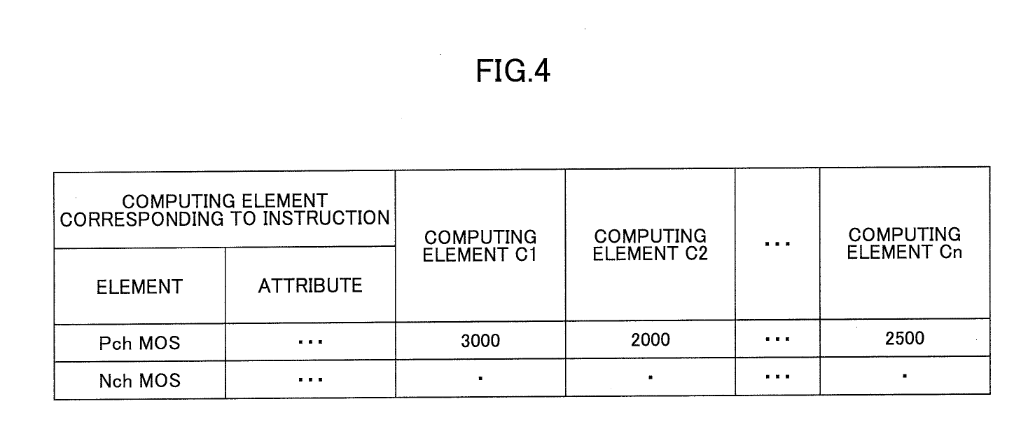

FIG. 4 is a diagram for illustrating yet another example of a way of setting a minimum set computing unit 11. It is noted that the numbers in the table illustrated in FIG. 4 are just examples and are not technically correct.

In the example illustrated in FIG. 4, the minimum set computing unit 11 is configured to include minimum elements as a unit of an element which is smaller than a unit of a gate at the gate level for AISIC logic synthesis. Specifically, the minimum set computing unit 11 is configured to include minimum elements as a unit of an element of PchMOSFET (Metal-Oxide-Semiconductor Field-Effect Transistor) and NchMOSFET. In other words, the minimum set computing unit 11 is configured to include minimum PchMOSFETs and NchMOSFETs required to be capable of configuring any one of all the computing elements C1, . . . , Cn.

Here, the example illustrated in FIG. 3 has a smaller unit (granularity) than the example illustrated in FIG. 2, and the example illustrated in FIG. 4 has a smaller unit than the example illustrated in FIG. 3. The smaller the unit becomes, the less the waste becomes. However, the smaller the unit becomes, the longer a time taken to configure the computing element described hereinafter using the minimum set computing unit 11 becomes.

The minimum set computing unit 11 thus configured is capable of configuring all the computing elements C1, . . . , Cn corresponding to all the instruction sets. Specifically, the minimum set computing unit 11 thus configured is capable of configuring all the computing elements C1, . . . , Cn by connecting the gates (or the elements) based on the corresponding connection information. The connection information may be prepared for the respective computing elements C1, . . . , Cn (i.e., for each instruction set of all the instruction sets) and stored in the memory. It is noted that the connection information is defined according to the minimum unit of the minimum set computing unit 11. For example, if the minimum set computing unit 11 is configured using the gate unit for FPGA synthesis as the minimum unit as is in the example illustrated in FIG. 2, the connection information is generated with the gate unit for FPGA synthesis (i.e., the information indicating the connecting way between the gates such as the AND gate, the OR gate) and stored. Further, if the minimum set computing unit 11 is configured using the gate unit for ASIC logic synthesis as the minimum unit as is in the example illustrated in FIG. 3, the connection information is generated with the gate unit for ASIC logic synthesis (i.e., the information indicating the connecting way between the gates of NAND, NOR and NOT) and stored. Further, if the minimum set computing unit 11 is configured using the element unit of PchMOSFET and NchMOSFET as the minimum unit as is in the example illustrated in FIG. 4, the connection information is generated with the element unit of PchMOSFET and NchMOSFET (i.e., the information indicating the connecting way between source/drain of the PchMOSFETs and source/drain of the NchMOSFETs) and stored.

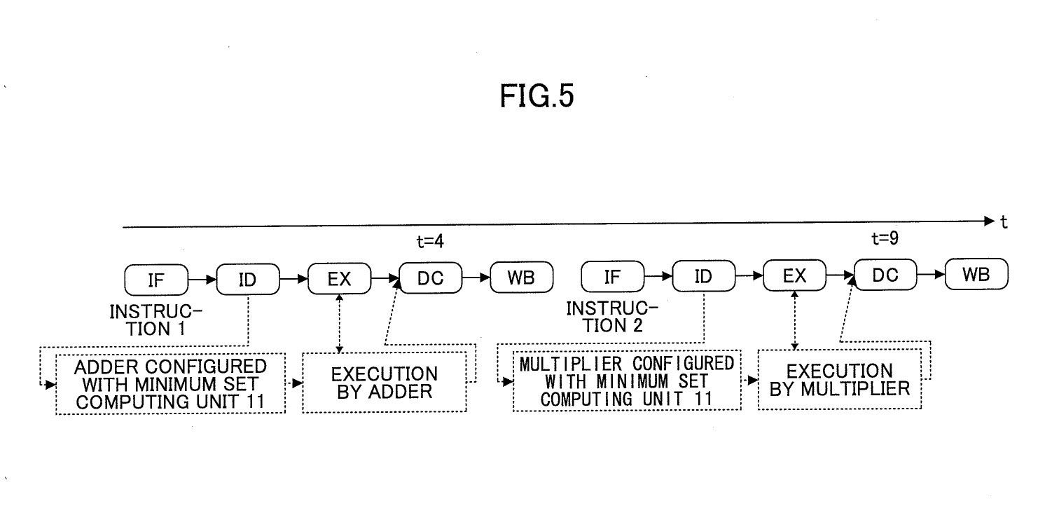

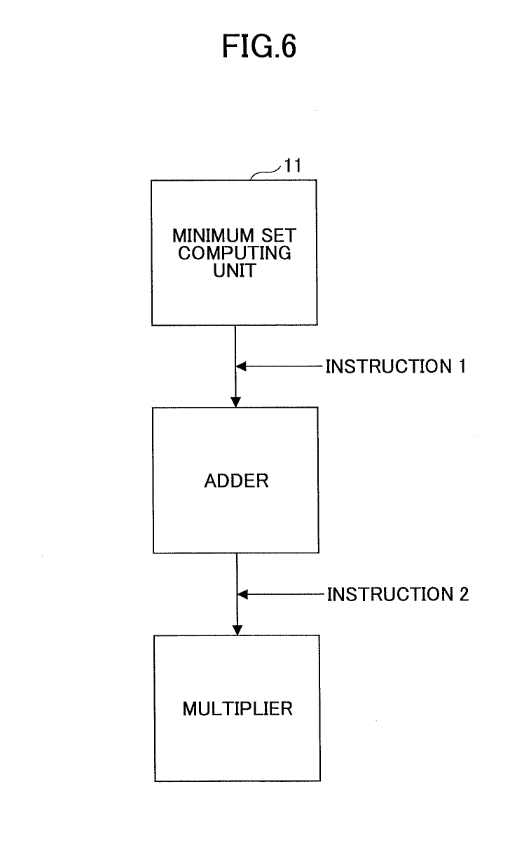

FIG. 5 is a diagram for illustrating an example of a time sequence in the case where a single-threaded operation (not pipelined) is implemented with a single minimum set computing unit 11 according to the embodiment. FIG. 6 is a diagram for illustrating a transition of the computing element configured by the minimum set computing unit 11 corresponding to FIG. 5. In FIGS. 5, t=4 and t=9 indicate the order of the clock assuming that the clock of IF of the instruction 1 is the first clock, and indicate the timing of clocks of Data Cache related to the instructions 1 and 2, respectively.

As illustrated in FIG. 5, in the illustrated example, the process is executed with a cycle of Fetch (IF), Decode (ID), Execute (EX), Data Cache (DC) and Write Back (WB).

In Fetch (IF), the instruction is retrieved from an instruction cache. In Decode (ID), the retrieved instruction is decoded and a register operand is fetched. In Execute (EX), the instruction (operation, etc.) is executed based on the decoded result and the fetched value of the register. Further, in the case of the Load/Store instruction, an execution address is computed, and in the case of the branch instruction, an address to be branched to is computed. However, the Execute process includes a computing element generating process with the minimum set computing unit 11 as described hereinafter in addition to these computing processes. In Data Cache (DC), a value of the memory corresponding to the address computed in the Execute process is read from the data cache. In Write Back (WB), the result of the operation in the Execute process or the operand fetched in the Data Cache process is stored in the register. Further, in the case of the store instruction, it is written in the data cache.

Here, as an example, it is assumed that the instruction 1 is an ADD (addition) instruction, and the instruction 2 is a MUL (multiplication) instruction. According to the embodiment, when the instruction 1 is fetched and the instruction 1 is decoded (interpreted), the computing element (adder) corresponding to the instruction 1 (addition) is configured with the minimum set computing unit 11 (see the adder after the instruction 1 in FIG. 6). Then, the operation is executed by the adder configured with the minimum set computing unit 11 (i.e., the instruction 1 is executed). The connection of the minimum set computing unit 11 for the adder and the operation by the configured adder are arranged such that they are completed before the timing of clock (t4) of DC related to the instruction 1 (the detail is described hereinafter). When the instruction 1 is executed, the operation result is stored in the register to end the process for the instruction 1.

When the process for the instruction 1 is ended, the instruction 2 is fetched and the instruction 2 is decoded (interpreted), the computing element (multiplier) corresponding to the instruction 2 (multiplication) is configured with the minimum set computing unit 11 (see the multiplier after the instruction 2 in FIG. 6). Then, the operation is executed by the multiplier configured with the minimum set computing unit 11 (i.e., the instruction 2 is executed). The connection of the minimum set computing unit 11 for the multiplier and the operation by the configured multiplier are arranged such that they are completed before the timing of clock (t9) of DC related to the instruction 2 (the detail is described hereinafter). When the instruction 2 is executed, the operation result is stored in the register to end the process for the instruction 2. It is noted that the connection of the minimum set computing unit 11 may be cleared (reset) whenever the process for the corresponding instruction is ended, or may be changed in an overwritten manner according to the respective instructions. In this way, the single-threaded operation is performed with the minimum set computing unit 11 according to the embodiment.

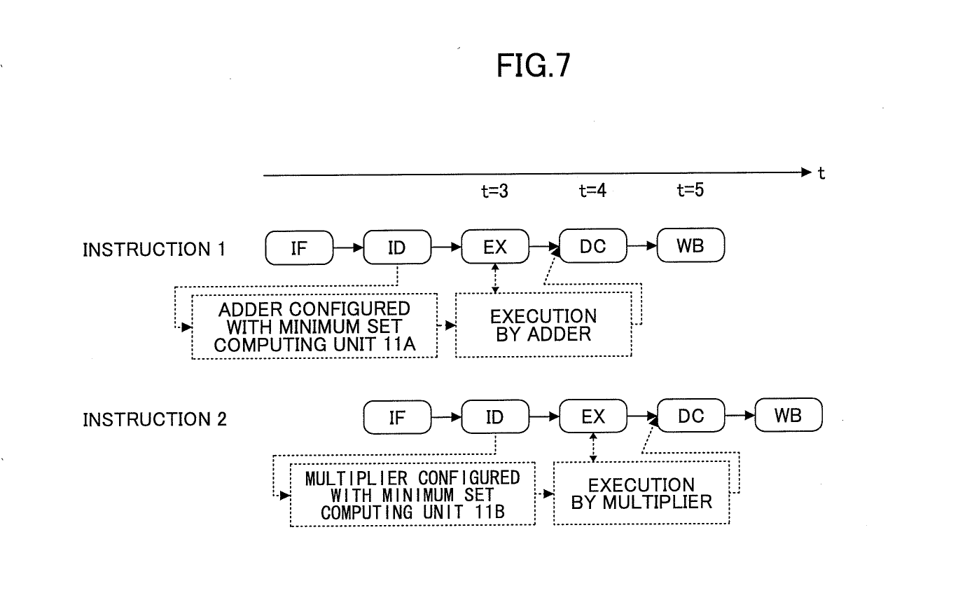

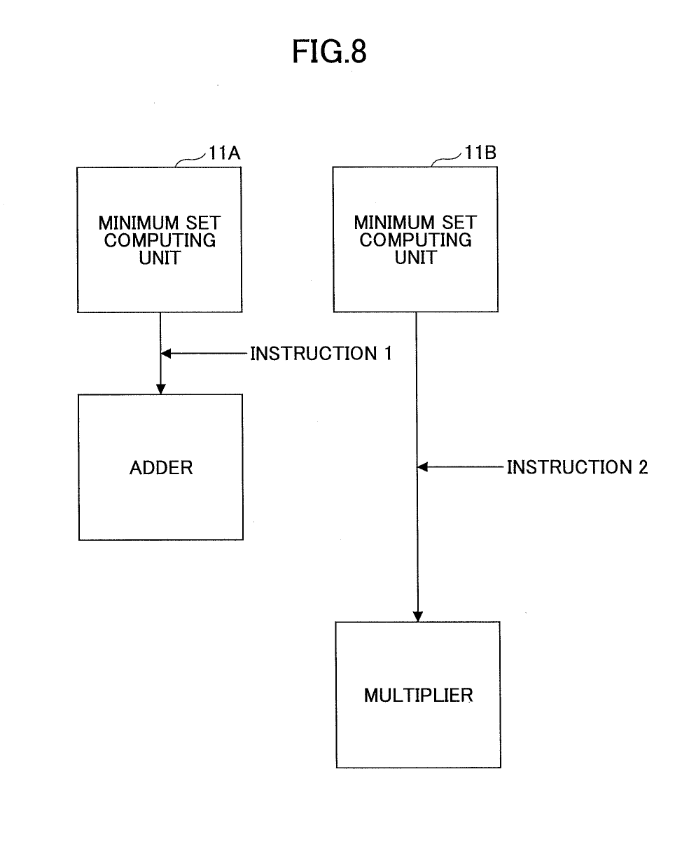

FIG. 7 is a diagram for illustrating an example of a time sequence in the case where a multi-threaded operation (two-stage pipeline) is implemented with two minimum set computing units 11 (indicated by 11A and 11B for a distinction, respectively) according to the embodiment. FIG. 8 is a diagram for illustrating a transition of computing elements configured by the minimum set computing units 11A and 11B corresponding to FIG. 7. In FIGS. 7, t=3, t=4 and t=5 indicate the order of the clock assuming that the clock of IF of the instruction 1 is the first clock, and indicate the timing of clock of Execute related to the instruction 1, the timing of clocks of Data Cache related to the instructions 1 and 2, respectively.

Similarly, in the illustrated example, the process is executed with a cycle of Fetch (IF), Decode (ID), Execute (EX), Data Cache (DC) and Write Back (WB).

Here, as an example, it is assumed that the instruction 1 is the ADD (addition) instruction, and the instruction 2 is the MUL (multiplication) instruction.

With respect to the instruction 1, when the instruction 1 is fetched and the instruction 1 is decoded (interpreted), the computing element (adder) corresponding to the instruction 1 (addition) is configured with the minimum set computing unit 11A (see the adder after the instruction 1 in FIG. 8). Then, the operation is executed by the adder configured with the minimum set computing unit 11A (i.e., the instruction 1 is executed). The connection of the minimum set computing unit 11A for the adder and the operation by the configured adder are arranged such that they are completed before the timing of clock (t4) of DC related to the instruction 1 (the detail is described hereinafter). When the instruction 1 is executed, the operation result is stored in the register to end the process for the instruction 1.

With respect to the instruction 2, when the instruction 2 is fetched and the instruction 2 is decoded (interpreted), the computing element (multiplier) corresponding to the instruction 2 (multiplication) is configured with the minimum set computing unit 11B (see the multiplier after the instruction 2 in FIG. 8). Then, the operation is executed by the multiplier configured with the minimum set computing unit 11B (i.e., the instruction 2 is executed). The connection of the minimum set computing unit 11B for the multiplier and the operation by the configured multiplier are arranged such that they are completed before the timing of clock (t5) of DC related to the instruction 2 (the detail is described hereinafter). When the instruction 2 is executed, the operation result is stored in the register to end the process for the instruction 2. In this way, the multi-threaded operation (two-stage pipeline) is performed with the minimum set computing units 11A and 11B according to the embodiment.

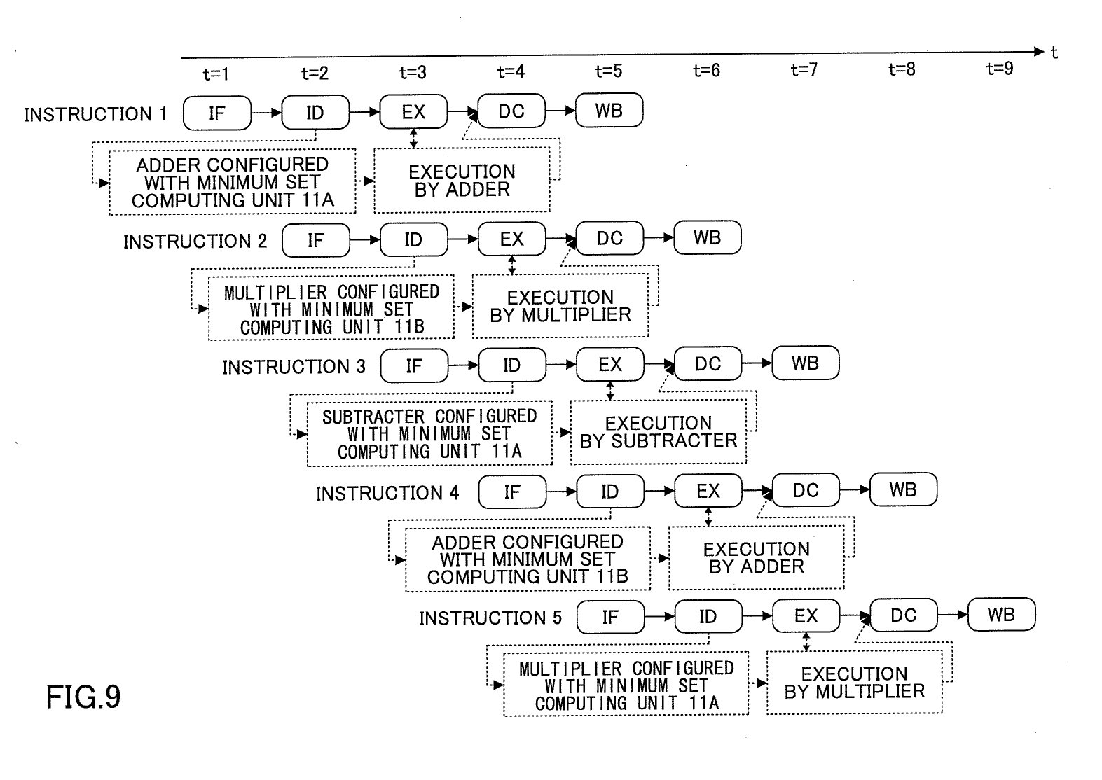

It is noted that the stage number of the pipeline of the multi-threaded operation (i.e., the number of the pipelines) is not limited to two, and may be three or more. The number of the minimum set computing units 11 may correspond to the stage number of the pipeline; however, as is described hereinafter with reference to FIG. 9, the minimum number of the minimum set computing units 11 are desirable.

FIG. 9 is a diagram for illustrating an example of a time sequence in the case where a multi-threaded operation (five-stage pipeline) is implemented with two minimum set computing units 11 (indicated by 11A and 11B for a distinction, respectively) according to the embodiment. In FIG. 9, t=1 through t=9 indicate the order of the clock assuming that the clock of IF of the instruction 1 is the first clock.

Here, as an example, it is assumed that the instruction 1 is the ADD (addition) instruction, the instruction 2 is the MUL (multiplication) instruction, the instruction 3 is a SUB (subtraction) instruction, the instruction 4 is the ADD (addition) instruction, and the instruction 5 is the MUL (multiplication) instruction.

With respect to the instruction 1, when the instruction 1 is fetched at t=1 and the instruction 1 is decoded (interpreted), the computing element (adder) corresponding to the instruction 1 (addition) is configured with the minimum set computing unit 11A. Then, the operation is executed by the adder configured with the minimum set computing unit 11A (i.e., the instruction 1 is executed). The connection of the minimum set computing unit 11A for the adder and the operation by the configured adder are arranged such that they are completed before the timing of clock (t4) of DC related to the instruction 1 (the detail is described hereinafter). When the instruction 1 is executed, the operation result is stored in the register to end the process for the instruction 1.

With respect to the instruction 2, when the instruction 2 is fetched at t=2 and the instruction 2 is decoded (interpreted), the computing element (multiplier) corresponding to the instruction 2 (multiplication) is configured with the minimum set computing unit 11B. Then, the operation is executed by the multiplier configured with the minimum set computing unit 11B (i.e., the instruction 2 is executed). The connection of the minimum set computing unit 11B for the multiplier and the operation by the configured multiplier are arranged such that they are completed before the timing of clock (t5) of DC related to the instruction 2 (the detail is described hereinafter). When the instruction 2 is executed, the operation result is stored in the register to end the process for the instruction 2.

With respect to the instruction 3, when the instruction 3 is fetched at t=3 and the instruction 3 is decoded (interpreted), the computing element (subtracter) corresponding to the instruction 3 (subtraction) is configured with the minimum set computing unit 11A. Then, the operation is executed by the subtracter configured with the minimum set computing unit 11A (i.e., the instruction 3 is executed). The connection of the minimum set computing unit 11A for the subtracter and the operation by the configured subtracter are arranged such that they are completed before the timing of clock (t6) of DC related to the instruction 3 (the detail is described hereinafter). When the instruction 3 is executed, the operation result is stored in the register to end the process for the instruction 3. It is noted that, with respect to the instruction 3, the minimum set computing unit 11A, which was used with respect to the instruction 1, is used to configure the subtracter. This is because Execute (EX) of the instruction 1 is completed before the Decode (ID) of the instruction 3 is completed and thus the minimum set computing unit 11A, which was used with respect to the instruction 1, becomes free (available).

With respect to the instruction 4, when the instruction 4 is fetched at t=4 and the instruction 4 is decoded (interpreted), the computing element (adder) corresponding to the instruction 4 (addition) is configured with the minimum set computing unit 11B. Then, the operation is executed by the adder configured with the minimum set computing unit 11B (i.e., the instruction 4 is executed). The connection of the minimum set computing unit 11B for the adder and the operation by the configured adder are arranged such that they are completed before the timing of clock (t7) of DC related to the instruction 4 (the detail is described hereinafter). When the instruction 4 is executed, the operation result is stored in the register to end the process for the instruction 4. Similarly, it is noted that, with respect to the instruction 4, the minimum set computing unit 11B, which was used with respect to the instruction 2, is used to configure the adder. This is because Execute (EX) of the instruction 2 is completed before the Decode (ID) of the instruction 4 is completed and thus the minimum set computing unit 11B, which was used with respect to the instruction 2, becomes free (available).

Similarly, with respect to the instruction 5, the minimum set computing unit 11A, which was used with respect to the instructions 1 and 3, is used to configure the corresponding computing element to execute the corresponding operation.

It is noted that, in the example illustrated in FIG. 9, two minimum set computing units 11A and 11B are used alternately on an instruction basis for the five-stage pipelined multi-threaded operation, thereby reducing the hardware resources while preventing the stall of the pipeline due to lack of the computing element. However, it is also possible to use three or four minimum set computing units that are used periodically in order for the five-stage pipelined multi-threaded operation. Such an idea can be applied according to the stage number of the pipeline, if necessary.

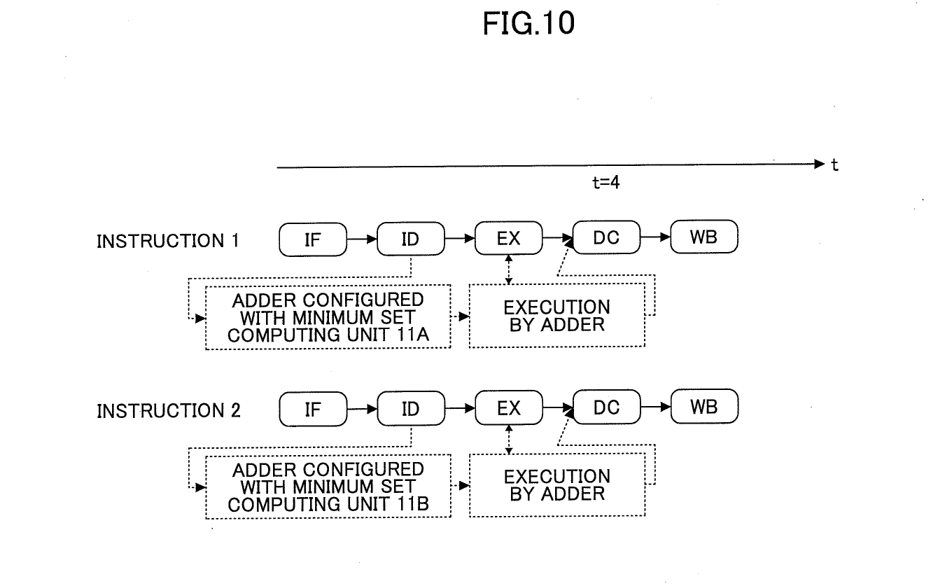

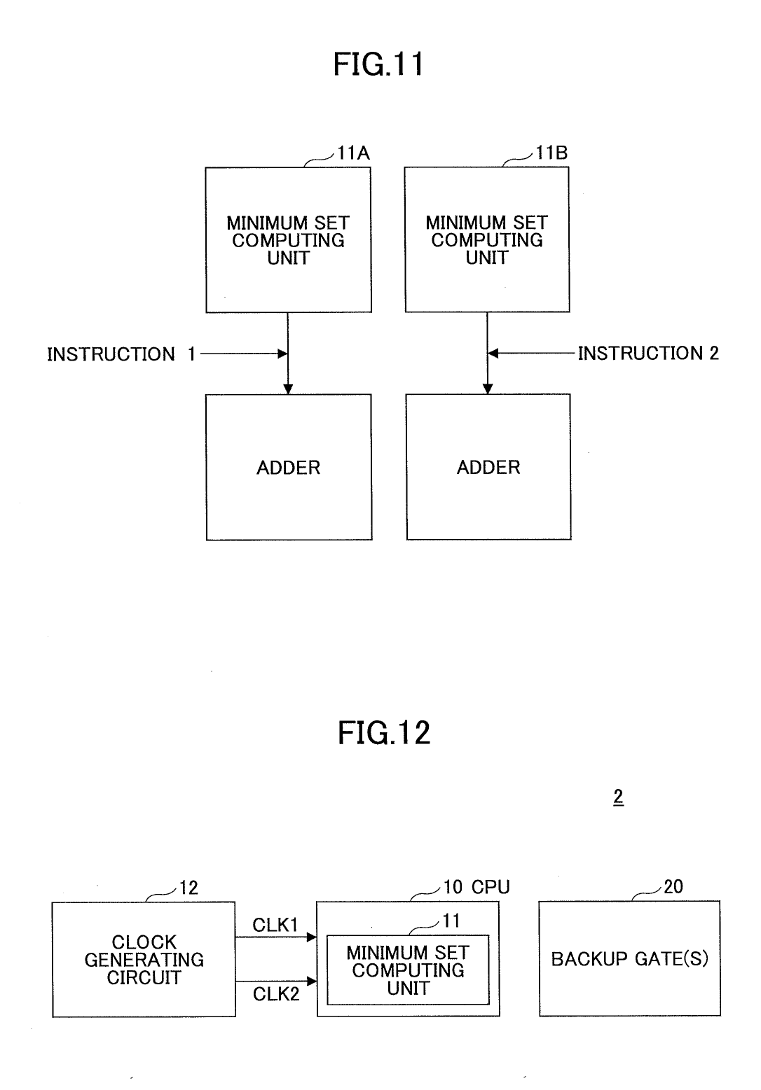

FIG. 10 is a diagram for illustrating an example of a time sequence in the case where a superscalar (parallel) operation is implemented with two minimum set computing units 11 (indicated by 11A and 11B for a distinction, respectively) according to the embodiment. FIG. 11 is a diagram for illustrating a transition of computing elements configured by the minimum set computing units 11A and 11B corresponding to FIG. 10.

Similarly, in the illustrated example, the process is executed with a cycle of Fetch (IF), Decode (ID), Execute (EX), Data Cache (DC) and Write Back (WB). Here, as an example, it is assumed that the instruction 1 is the ADD (addition) instruction, and the instruction 2 is the ADD (addition) instruction.

In the example illustrated in FIG. 10, when the instruction 1 is fetched and the instruction 1 is decoded (interpreted), the computing element (adder) corresponding to the instruction 1 (addition) is configured with the minimum set computing unit 11A (see the adder after the instruction 1 in FIG. 11). When the instruction is fetched simultaneously with the instruction 1 and the instruction 2 is decoded (interpreted), the computing element (adder) corresponding to the instruction 2 (addition) is configured with the minimum set computing unit 11B (see the adder after the instruction 2 in FIG. 10). Then, the operations are executed by the adders configured with the minimum set computing units 11A and 11B, respectively (i.e., the instructions 1 and 2 are executed simultaneously). The connections of the minimum set computing units 11A and 11B for the adders and the operations by the configured adders are arranged such that they are completed before the timing of clock (t4) of DC related to the instructions 1 and 2 (the detail is described hereinafter). When the instructions 1 and 2 are executed, the respective operation results are stored in the registers to end the processes for the instructions 1 and 2. In this way, the superscalar operation is performed with the minimum set computing units 11A and 11B according to the embodiment.

It is noted that the number of the processes performed in parallel (parallel numbers) is not limited to two, and may be three or more. In any case, the number of the minimum set computing units 11 corresponds to the parallel numbers. With this arrangement, it is possible to prevent the stall of the pipeline due to lack of the computing element.

FIG. 12 is a diagram for schematically illustrating a configuration of a dynamically reconfigurable processor 2 according to another embodiment (second embodiment) of the present invention.

The dynamically reconfigurable processor 2 according to the embodiment includes one or more backup gates 20 in addition to the CPU 10 and the clock generating circuit 12. The configuration and operations of the CPU 10, in particular, the configuration and operations of the minimum set computing unit 11 may be the same as those in the first embodiment described above.

If a part of the gates of the minimum set computing unit 11 fails, the backup gate(s) 20 is used instead of the failed gate(s). Specifically, if a part of the gates of the minimum set computing unit 11 fails, the operation can be continued by stopping the failed gate(s) and changing the connection such that the backup gate(s) 20 is used. It is noted that a method of detecting the failure of the gate and a method of stopping the gate may be arbitrary, and methods which are commonly used in the field of a failure recovering technique may be used.

For this purpose, the number of the backup gate(s) 20 is smaller than the number of all the gates included in the minimum set computing unit 11, and the unit of the backup gate(s) 20 corresponds to the minimum unit of the gates of the minimum set computing unit 11. For example, if the minimum set computing unit 11 is configured using the gate unit for FPGA synthesis as the minimum unit as is in the example illustrated in FIG. 2, the backup gate(s) 20 is configured with the gate unit for FPGA synthesis. For example, if the minimum set computing unit 11 is configured using the gate unit for AISIC logic synthesis as the minimum unit as is in the example illustrated in FIG. 3, the backup gate(s) 20 is configured with the gate unit for AISIC logic synthesis. Further, if the minimum set computing unit 11 is configured using the element unit of PchMOSFET and NchMOSFET as the minimum unit as is in the example illustrated in FIG. 4, the backup gate(s) 20 may be replaced with one or more backup elements of PchMOSFET and NchMOSFET.

If the minimum set computing unit 11 is configured using the gate unit as the minimum unit as is in the examples illustrated in FIG. 2 and FIG. 3, the backup gate(s) 20 may include only predetermined gate(s) (the gate(s) which is used with high frequency, for example) of all the gates in the minimum set computing unit 11. Alternatively, the minimum set computing unit 11 is configured using the gate unit as the minimum unit as is in the examples illustrated in FIG. 2 and FIG. 3, the backup gates 20 may include all the types of the gates in the minimum set computing unit 11 such that the backup gates 20 include one gate on a gate type basis.

In this way, according to the second embodiment, since the backup gate(s) 20 or element(s) is configured with the unit at the gate level or at the element level, the number of the gates or elements prepared for the backup for the failure can be reduced, in comparison with a solution in which backup computing elements as a unit of a computing element is prepared, thereby implementing the backup configuration with the reduced area. It is noted that the backup gate(s) 20 is illustrated separately from the minimum set computing. unit 11 in FIG. 12 for the sake of the explanation; however, the backup gate(s) 20 may be configured integrally with the minimum set computing unit 11 (i.e., the backup gate(s) 20 may be incorporated into the minimum set computing unit 11).

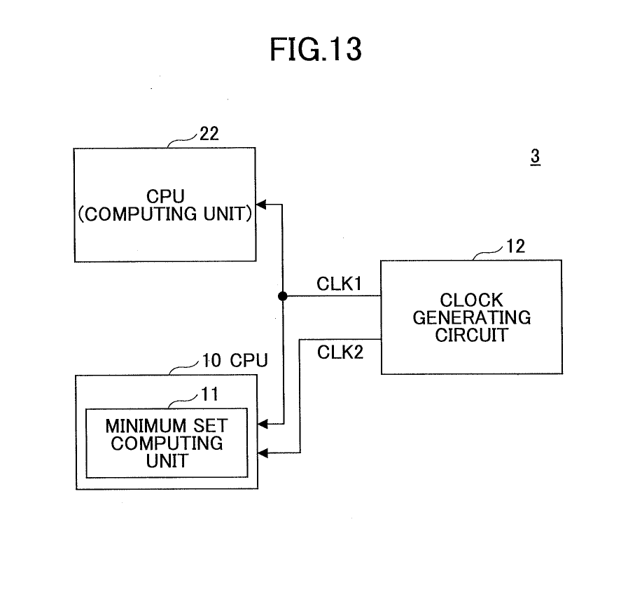

FIG. 13 is a diagram for schematically illustrating a configuration of a dynamically reconfigurable processor 3 according to another embodiment (third embodiment) of the present invention.

The dynamically reconfigurable processor 3 according to the embodiment includes a CPU (computing unit) 22 in addition to the CPU 10 and the clock generating circuit 12. The configuration and operations of the CPU 10, in particular, the configuration and operations of the minimum set computing unit 11 may be the same as those in the first embodiment described above.

The CPU 22 may be a CPU for general purpose use, and includes plural computing elements (non-reconfigurable computing elements) as hardware resources. It is noted that the CPU 22 may be configured integrally with the CPU 10. In other words, the computing elements (non-reconfigurable computing elements) in the CPU 22 may be incorporated into the CPU 10 separately from the minimum set computing unit 11 in the CPU 10. In this case, hardware resources (hardware resources other than the computing elements, such as an instruction decoder control circuit) which can be shared may be unified.

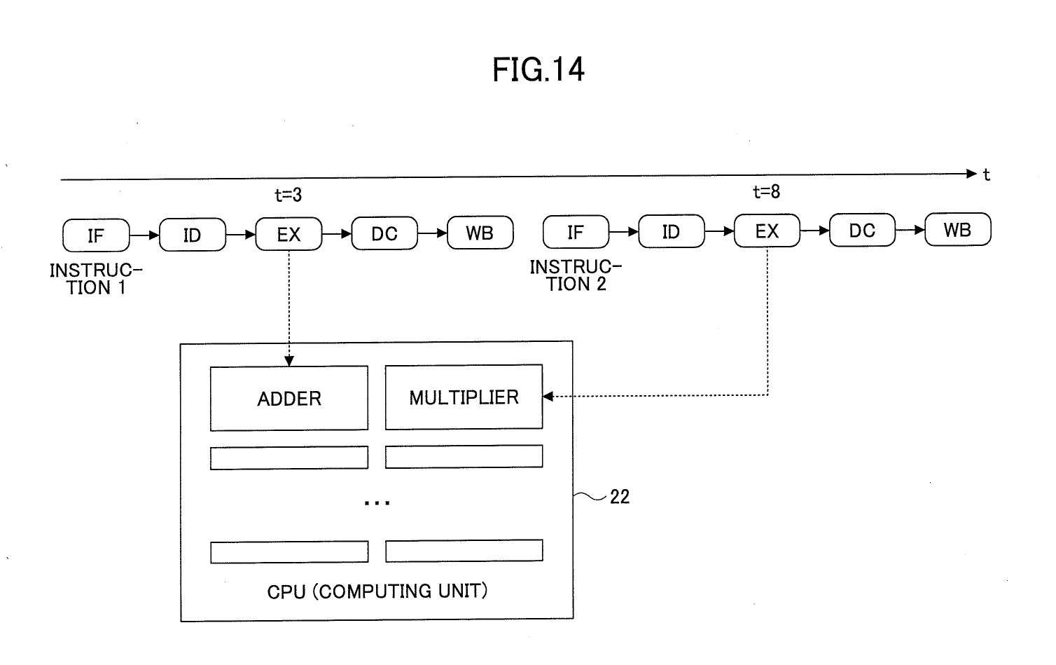

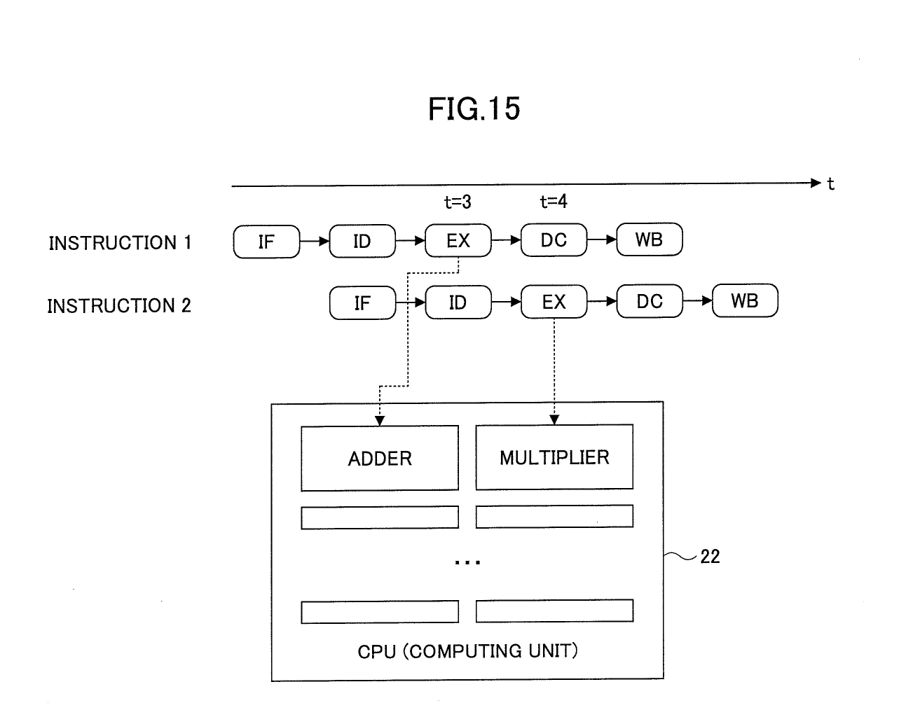

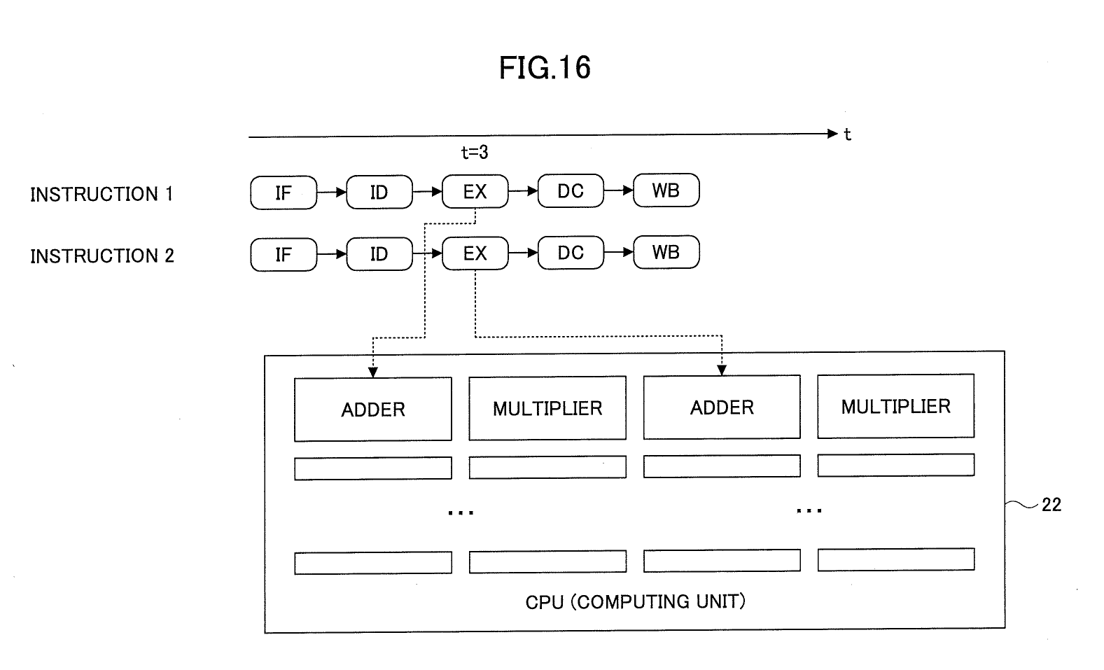

FIG. 14, FIG. 15 and FIG. 16 illustrate examples of the respective operations (single-threaded operation, multi-threaded operation and superscalar operation) of the CPU 22, respectively, and provide contrast with FIG. 5, FIG. 7 and FIG. 10 which illustrate examples of the same operations of the minimum set computing unit 11, respectively.

The respective operations of the CPU 22 may be ordinary as is illustrated in FIG. 14, FIG. 15 and FIG. 16.

For example, if the case of the single-threaded operation, when the instruction 1 (addition instruction) is fetched and the instruction 1 is decoded (the instruction 1 is interpreted), the operation is performed with the adder in the CPU 22 at the timing of clock (t=3) of Execute (EX), as illustrated in FIG. 14. When the instruction 1 is thus executed, the operation result is stored in the register to end the process for the instruction 1. Then, when the instruction 2 (multiplication instruction) is fetched and the instruction 2 is decoded (the instruction 2 is interpreted), the operation is performed with the multiplier in the CPU 22 at the timing of clock (t=8) of Execute (EX). When the instruction 2 is thus executed, the operation result is stored in the register to end the process for the instruction 2. In this way, the single-threaded operation is performed by performing various kinds of operations using various kinds of computing elements in the CPU 22 which are prepared in advance as the hardware resources according to various kinds of instructions.

Similarly, in the case of the multi-threaded operation, various kinds of operations are performed using various kinds of computing elements in the CPU 22 which are prepared in advance as the hardware resources according to various kinds of instructions, as illustrated in FIG. 15. Similarly, in the case of the superscalar operation, various kinds of operations are performed using various kinds of computing elements in the CPU 22 which are prepared in advance as the hardware resources according to various kinds of instructions, as illustrated in FIG. 16. It is noted that, in FIGS. 14 through 16, particular types of the computing elements in the CPU 22 are illustrated; however, other types of the computing elements may be included in fact. It is noted that, for the sake of the superscalar (parallel) operation, the CPU 22 illustrated in FIG. 16 includes more computing elements than the CPU 22 illustrated in FIG. 14 or FIG. 15. Since the parallel number is two, the CPU 22 illustrated in FIG. 16 may have completely twice as many computing elements as the CPU 22 illustrated in FIG. 14 or FIG. 15; however, the CPU 22 illustrated in FIG. 16 may have more computing elements than the CPU 22 illustrated in FIG. 14 or FIG. 15 to some degree.

The dynamically reconfigurable processor of the third embodiment is configured to selectively use the minimum set computing unit 11 or the CPU 22 according to the instruction. The way of selectively using the minimum set computing unit 11 or the CPU 22 according to the instruction may be arbitrary.

As an example, the instructions which are used with high frequency may be executed by the computing elements in the CPU 22 while only the instructions which are used with low frequency may be executed by the computing elements which are dynamically configured with the minimum set computing unit 11. With this arrangement, the area reduction is enhanced by the minimum set computing unit 11 while the high-speed operation is assured with the CPU 22. It is noted that in fact the instructions which are used with high frequency are limited even though it depends on the compiler, and thus the area reduction effect is not reduced greatly. Whether the instruction is used with high frequency or low frequency may be based on a relative criterion, and may be determined in terms of a trade-off between the demand for the high-speed operation and the demand for the area reduction. The frequencies of the respective instructions may be determined by performing the instruction analysis in the application for which the dynamically reconfigurable processor 3 is used most. In this way, an adequate balance between the cost and the speed can be obtained by performing the architecture design in conjunction with the complier technique.

In another example, the minimum set computing unit 11 may be used temporarily under the situation where the stall of the pipeline may occur, that is to say, if the number of the same instructions issued simultaneously exceeds the number of the computing elements in the CPU 22 (if the instructions which cannot be handled with the computing elements in the CPU 22 are issued). Specifically, the CPU 22 performs the operations in the normal state, and if the instruction group which cannot be handled with the computing elements in the CPU 22 is issued, the computing element according to the instruction which cannot be executed by the computing elements in the CPU 22 may be dynamically configured with the minimum set computing unit 11. In this case, the instruction which cannot be executed by the computing elements in the CPU 22 is executed by the computing element thus configured with the minimum set computing unit 11.

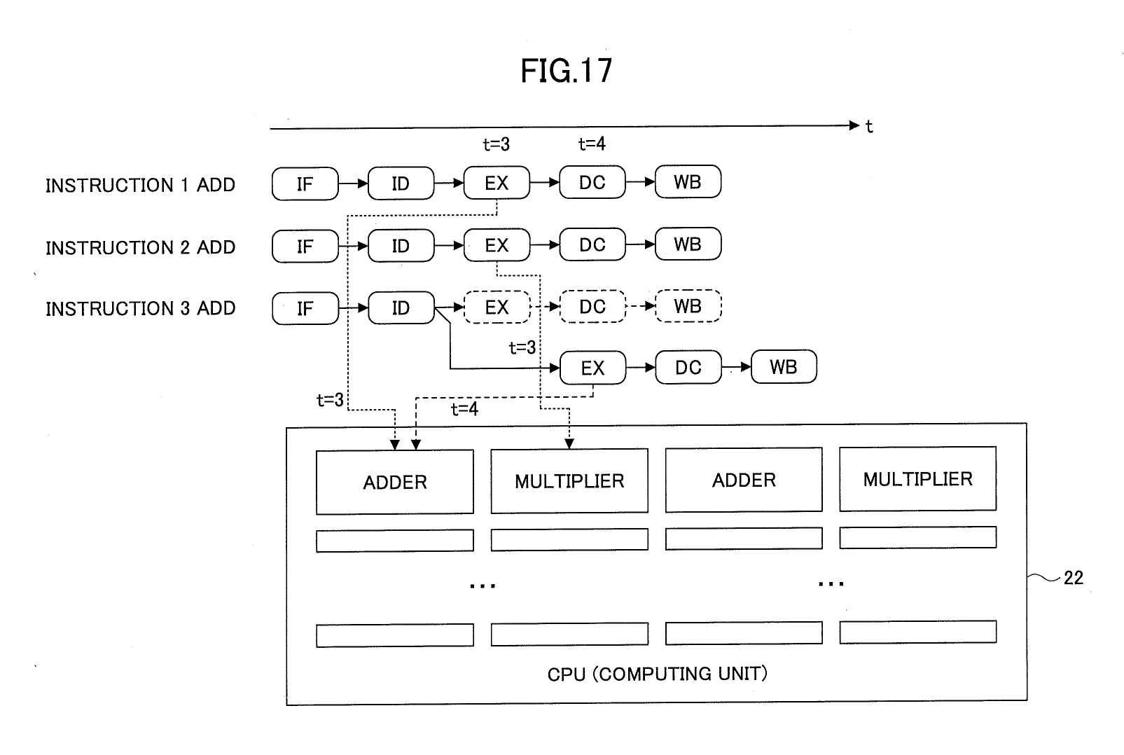

For example, as illustrated in FIG. 17, if there are only two adders in the CPU 22 when the addition instructions 1, 2 and 3 are issued simultaneously, it would necessarily lead to the stall of the pipeline with respect to the instruction 3 and the waiting status. In contrast, according to the embodiment, as illustrated in FIG. 18, the adder is configured with the minimum set computing unit 11 when it is found out that the instructions which cannot be handled with the computing elements in the CPU 22 are issued, thereby preventing the stall. In the example illustrated in FIG. 18, the instructions 1 and 2 are executed by the computing elements (two adders) included in the CPU 22, while the instruction 3 is executed by the adder configured with the minimum set computing unit 11. Similarly, in the example illustrated in FIG. 18, the connection of the minimum set computing unit 11 for the adder and the operation by the configured adder are arranged such that they are completed before the timing of clock (t4) of DC (the detail is described hereinafter).

Next, the arrangement (in particular, the configuration and the function of the clock generating circuit 12) for completing the connection of the minimum set computing unit 11 for the adder and the operation by the configured adder before the timing of clock of DC (i.e, the clock for the process for storing the operation result) at latest is described.

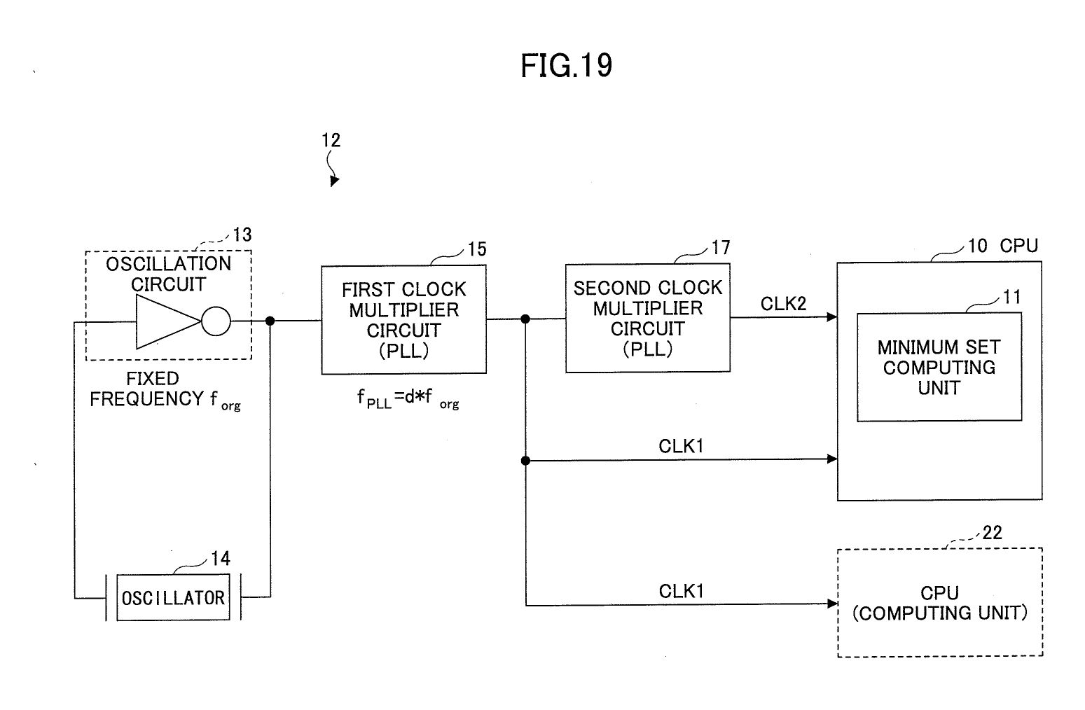

FIG. 19 is a diagram for illustrating an example of a configuration of the clock generating circuit 12 (first delay prevention method). The clock generating circuit 12 includes an oscillation circuit 13, a first clock multiplier circuit 15 and a second clock multiplier circuit 17. The oscillation circuit 13 is connected to an oscillator 14. It is noted that the oscillator 14 may be provided in the dynamically reconfigurable processor 1, 2 or 3. The output of the oscillation circuit 13 is connected to the first clock multiplier circuit 15. The output of the first clock multiplier circuit 15 is connected to the second clock multiplier circuit 17. In the case of the dynamically reconfigurable processor 1 or 2 according to the first or second embodiment, the output of the first clock multiplier circuit 15 is connected to the CPU 10. In the case of the dynamically reconfigurable processor 3 according to the third embodiment, the output of the first clock multiplier circuit 15 is connected to the CPU 10 and the CPU 22.

In a typical example, the first clock multiplier circuit 15 is configured with the PLL (Phase Locked Loop). The first clock multiplier circuit 15 multiplies the frequency f_{org} (internal clock frequency) of the clock source signal excited by the oscillation circuit 13, as follows. f_{PLL1}=d×f_{org} Where f_{PLL1} indicates the frequency of the clock CLK1 from the first clock multiplier circuit 15. It is noted that the first clock multiplier circuit 15 may be omitted in the case of the low frequency; however, in general, in the case of the frequency higher than tens MHz, the first clock multiplier circuit 15 is required for multiplying the frequency excited by the oscillation circuit 13.

The output of the first clock multiplier circuit 15 is input to the CPU 10 (or the CPU 10 and the CPU 22) and functions as the main clock CLK1.

In a typical example, the second clock multiplier circuit 17 is configured with the PLL (Phase Locked Loop). The second clock multiplier circuit 17 multiplies (doubles, in this example) the frequency of the clock CLK1 output from the first clock multiplier circuit 15, as follows. f_{PLL2}=2×f_{PLL1} With this arrangement, the clock CLK2, which is synchronized with the clock CLK1 and has the doubled frequency of the clock CLK1, is generated. The clock CLK2 is input to the CPU 10. It is noted that the second clock multiplier circuit 17 may be provided in parallel with the first clock multiplier circuit 15. In this case, the second clock multiplier circuit 17 multiplies the frequency f_{org} (internal clock frequency) of the clock source signal excited by the oscillation circuit 13 with the coefficient which corresponds to the doubled coefficient d of the first clock multiplier circuit 15, as follows. f_{PLL1}=2×d×f_{org}

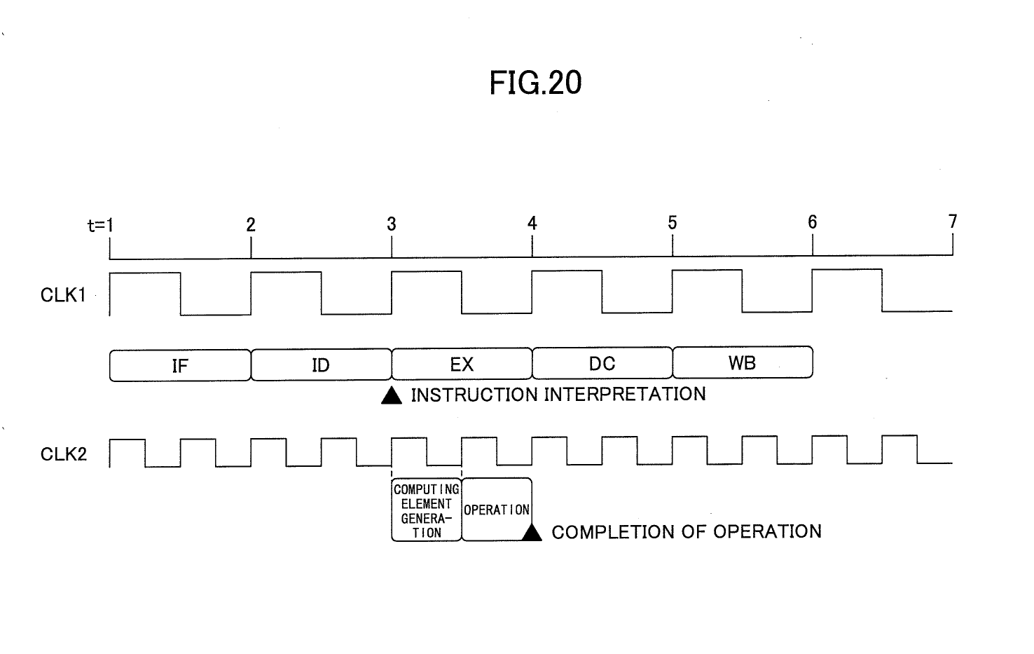

FIG. 20 is a diagram for illustrating a principal of a delay prevention function (first delay prevention method) implemented by the clock generating circuit 12 illustrated in FIG. 19. In FIG. 20, the waveshape of the clock CLK1 and the process of one cycle (Fetch (IF), Decode (ID), Execute (EX), Data Cache (DC) and Write Back (WB)) are illustrated in time series. In FIG. 20, t=1 through t=7 indicate the order of the clock assuming that the clock of IF of the instruction 1 is the first clock. Further, in FIG. 20, the timing of the generating process (computing element generation) of the computing element with the minimum set computing unit 11 and the timing of the operation process (operation) by the computing element configured with the minimum set computing unit 11 are illustrated together with the waveshape of the clock CLK2. Further, in FIG. 20, the timing of the interpretation of the instruction in Decode (ID) is indicated by the arrow.

The respective processes of Fetch (IF), Decode (ID), Data Cache (DC) and Write Back (WB) are executed based on the clock CLK1. Specifically, the respective processes of Fetch (IF), Decode (ID), Data Cache (DC) and Write Back (WB) are triggered to start at the rising edges (t=1, 2, 4 and 5) of the clock CLK1, respectively.

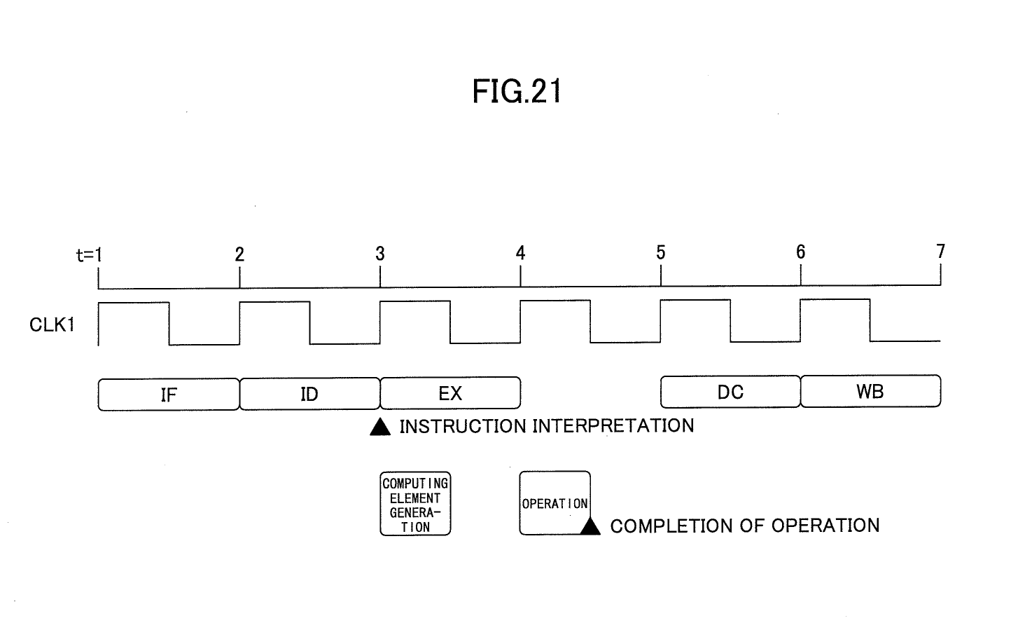

On the other hand, according to the embodiment, since Execute (EX) includes two processes, that is to say, the generation (connection) of the computing element with the minimum set computing unit 11 and the operation by the generated computing element, two rising edges of the clock CLK1 could be necessary. However, as illustrated in FIG. 21 as contrast, if two clock periods of the clock CLK1 are given to Execute (EX), the processes of Data Cache (DC) and Write Back (WB) are delayed correspondingly (by one clock period of the clock CLK1).

Therefore, in the examples illustrated in FIG. 19 and FIG. 20, the generating process (connection based on the connection information) of the computing element with the minimum set computing unit 11 and the computing process by the computing element generated with the minimum set computing unit 11 are executed based on the clock CLK2 which is the doubled clock of the clock CLK1. With this arrangement, as illustrated in FIG. 20, the generating process (computing element generation) of the computing element with the minimum set computing unit 11 and the computing process (operation) by the computing element generated with the minimum set computing unit 11 can be completed before the rising edge (t=4) of the clock CLK1 for Data Cache (DC). In other words, by performing the computing element generation and the operation at high-speed using the multiplied clock, the respective processes of Fetch (IF), Decode (ID), Execute (EX), Data Cache (DC) and Write Back (WB) can be performed without such a delay as illustrated in FIG. 21.

It is noted that the explanation described above with reference to FIG. 20 is related to the operation of the CPU 10 of the dynamically reconfigurable processor 1, 2 or 3 according to the first, second or third embodiment. The operation of the CPU 22 of the dynamically reconfigurable processor 3 according to the third embodiment may be ordinary. Specifically, in the CPU 22 of the dynamically reconfigurable processor 3, the respective processes of Fetch (IF), Decode (ID), Execute (EX), Data Cache (DC) and Write Back (WB) are executed based on the clock CLK1 as usual.

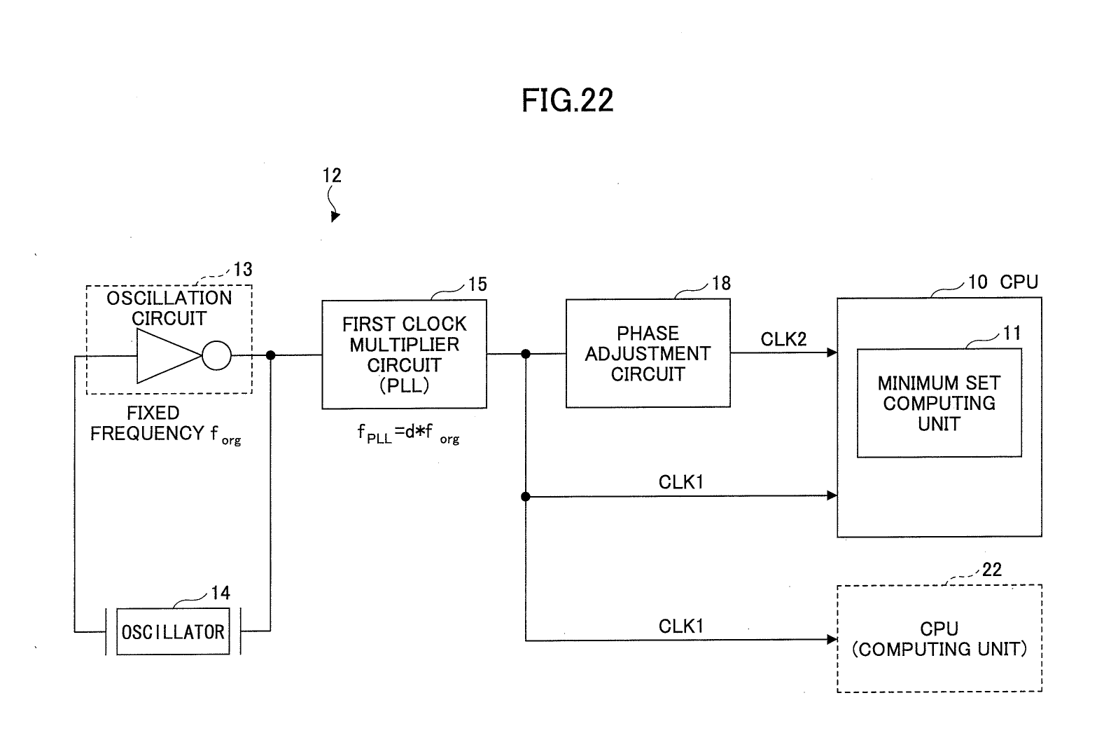

FIG. 22 is a diagram for illustrating another example of a configuration of a clock generating circuit 12 (second delay prevention method). The clock generating circuit 12 illustrated in FIG. 22 differs from the example illustrated in FIG. 19 mainly in that it includes a phase adjustment circuit 18 instead of the second clock multiplier circuit 17. Other configurations may be the same.

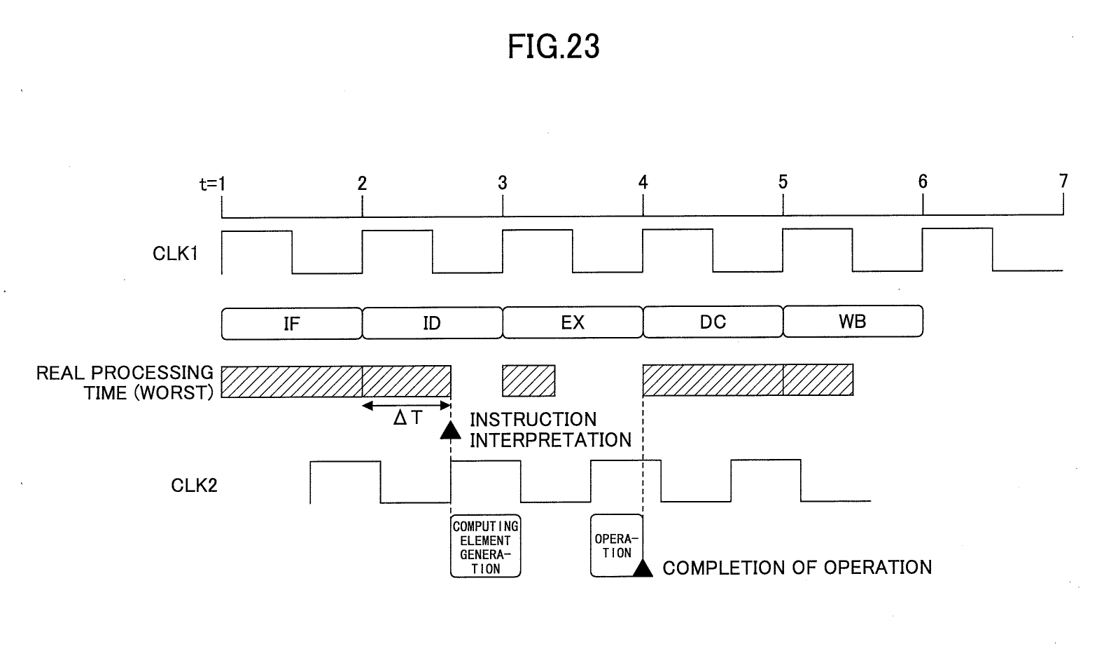

The phase adjustment circuit 18 generates the clock CLK2 by shifting the phase of the clock CLK1 output from the first clock multiplier circuit by a predetermined phase amount. The predetermined phase amount is set based on the longest time ΔT (possibly the worst time) of the times (real processing times) which can be taken to perform the process of Decode (ID). The predetermined phase amount is determined within a phase range which corresponds to the time which is longer than the longest time ΔT of Decode (ID) (see FIG. 23) and shorter than one clock period of the clock CLK1. However, it is preferred that the predetermined phase amount is set such that it corresponds to the longest time ΔT of Decode (ID) so that the generating process (computing element generation) of the computing element with the minimum set computing unit 11 can be started as soon as possible. Here, the explanation is continued assuming that the predetermined phase amount is set such that it corresponds to the longest time ΔT of Decode (ID).

FIG. 23 is a diagram for illustrating a principal of a delay prevention function (second delay prevention method) implemented by the clock generating circuit 12 illustrated in FIG. 22. In FIG. 23, the waveshape of the clock CLK1 and the process of one cycle (Fetch (IF), Decode (ID), Execute (EX), Data Cache (DC) and Write Back (WB)) are illustrated in time series. In FIG. 23, t=1 through t=7 indicate the order of the clock assuming that the clock of IF of the instruction 1 is the first clock. Further, in FIG. 23, the timing of the generating process (computing element generation) of the computing element with the minimum set computing unit 11 and the timing of the operation process (operation) by the computing element configured with the minimum set computing unit 11 are illustrated together with the waveshape of the clock CLK2. Further, in FIG. 23, the longest times (real processing times) required to perform Fetch (IF), Decode (ID), Execute (EX), Data Cache (DC) and Write Back (WB), respectively, are illustrated. Further, the timing (in the worst case) at which the interpretation of the instruction of Decode (ID) is completed is indicated by the arrow. It is noted that the longest time ΔT of Decode (ID) is from the rising edge of the clock CLK1 for Decode (ID) (t=2) to the timing at which the interpretation of the instruction is completed.

Similarly, The respective processes of Fetch (IF), Decode (ID), Data Cache (DC) and Write Back (WB) are executed based on the clock CLK1. On the other hand, in the examples illustrated in FIG. 22 and FIG. 23, the generating process (computing element generation) of the computing element with the minimum set computing unit 11 and the computing process (operation) by the computing element generated with the minimum set computing unit 11 are executed based on the clock CLK2 which is phase-shifted with respect to the clock CLK1. In other words, the execution of the generating process (computing element generation) of the computing element with the minimum set computing unit 11 is started based on the clock CLK2 at the timing at which the interpretation of the instruction is completed. Thus, the execution of the generating process is started before the rising edge (t=3) subsequent to the rising edge (t=2) of the clock CLK1 for Decode (ID). Further, the execution of the computing process (operation) by the computing element generated with the minimum set computing unit 11 is started at the next rising edge of the clock CLK2. With this arrangement, as illustrated in FIG. 23, the generating process (computing element generation) of the computing element with the minimum set computing unit 11 and the computing process (operation) by the computing element generated with the minimum set computing unit 11 can be completed before the rising edge (t=4) of the clock CLK1 for Data Cache (DC). In other words, by using the two-phase clock, the respective processes of Fetch (IF), Decode (ID) , Execute (EX), Data Cache (DC) and Write Back (WB) can be performed without such a delay as illustrated in FIG. 21.

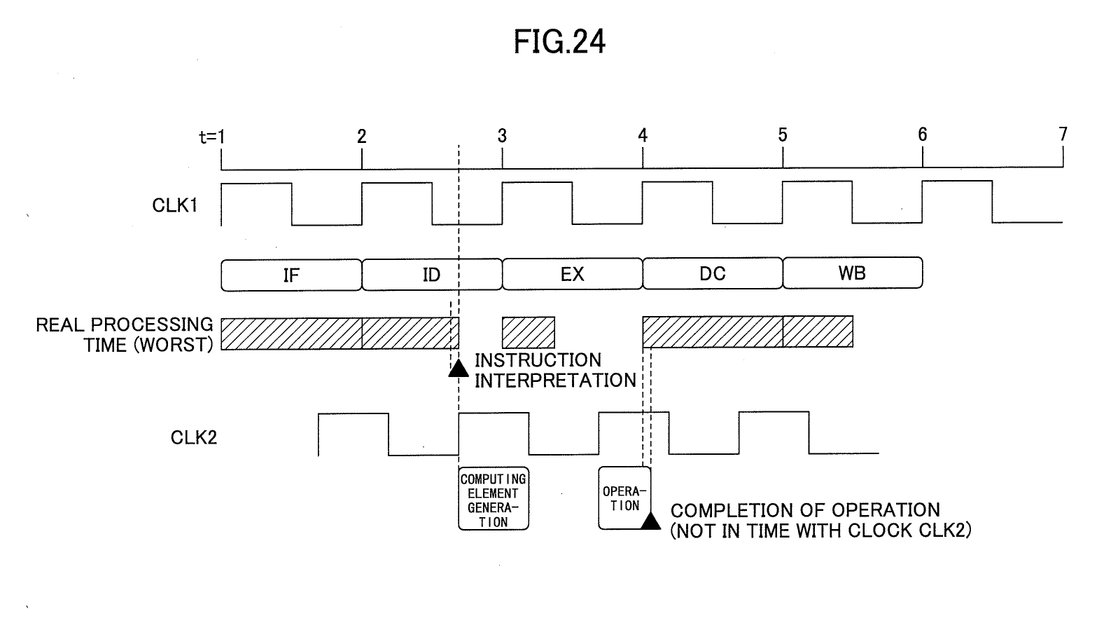

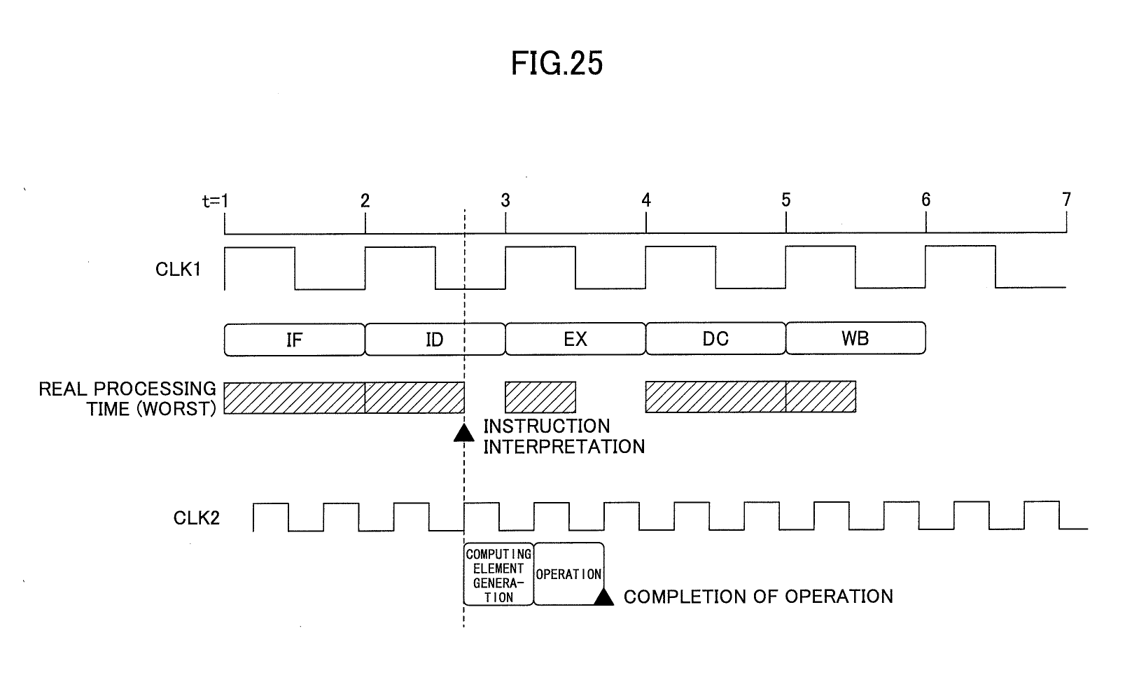

It is noted that the explanation described above with reference to FIG. 23 is related to the operation of the CPU 10 of the dynamically reconfigurable processor 1, 2 or 3 according to the first, second or third embodiment. The operation of the CPU 22 of the dynamically reconfigurable processor 3 according to the third embodiment may be ordinary. Specifically, in the CPU 22 of the dynamically reconfigurable processor 3, the respective processes of Fetch (IF), Decode (ID), Execute (EX), Data Cache (DC) and Write Back (WB) are executed based on the clock CLK1 as usual. This is also true for the explanation with reference to FIG. 24 and FIG. 25 hereinafter.

By the way, there may be a case where even the first and second delay prevention methods described above cannot prevent the delay, depending on the relationship between one clock period (i.e., a cycle) of the clock CLK1 and the longest time ΔT of Decode (ID), the time required for the generating process (computing element generation) of the computing element with the minimum set computing unit 11, the time required for the computing process (operation) by the computing element generated with the minimum set computing unit 11, etc. In such a case, the delay can be prevented by combining the first and second delay prevention methods, and/or performing the three times multiplication or more in the first delay prevention method.

For example, as illustrated in FIG. 24, if the longest time ΔT of Decode (ID) is longer than that in the example illustrated in FIG. 23, the phase shift amount of the clock CLK2 with respect to the clock CLK1 becomes greater correspondingly, and thus the generating process (computing element generation) of the computing element with the minimum set computing unit 11 and the computing process (operation) by the computing element generated with the minimum set computing unit 11 cannot be completed before the rising edge (t=4) of the clock CLK1 for Data Cache (DC). In this case, as illustrated in FIG. 25, for example, by combining the first and second delay prevention methods, the generating process (computing element generation) of the computing element with the minimum set computing unit 11 and the computing process (operation) by the computing element generated with the minimum set computing unit 11 can be completed before the rising edge (t=4) of the clock CLK1 for Data Cache (DC).

The present invention is disclosed with reference to the preferred embodiments. However, it should be understood that the present invention is not limited to the above-described embodiments, and variations and modifications may be made without departing from the scope of the present invention.

For example, in the embodiments described above, using two clocks CLK1 and CLK2 enables that the generating process (computing element generation) of the computing element with the minimum set computing unit 11 and the computing process (operation) by the computing element generated with the minimum set computing unit 11 are completed before the start timing of Data Cache (DC). However, three or more clocks may be used. For example, two clocks, which are phase-shifted differently with respect to the clock CLK1, may be generated, and the generating process (computing element generation) of the computing element with the minimum set computing unit 11 and the computing process (operation) by the computing element generated with the minimum set computing unit 11 may be performed based on the respective clocks.

Further, in the embodiments described above, the process of Execute (EX) to be performed by the minimum set computing unit 11 is divided into two processes (sub-processes), that is to say, the generating process (computing element generation) of the computing element with the minimum set computing unit 11 and the computing process (operation) by the computing element generated with the minimum set computing unit 11. However, the process of Execute (EX) may be divided into three or more processes. For example, the generating process of the computing element with the minimum set computing unit 11 may be divided into the process of reading the connection information according to the instruction and the process of generating the computing element with the minimum set computing unit 11 based on the read connection information. Similarly, in this case, by using the three-phase clock or the multiplied clock, the process of Execute (EX) can be completed before the start timing of Data Cache (DC).

Further, the clocks CLK1 and CLK2 do not necessarily have the same frequency constantly, as long as they can provide the triggers for the respective processes at the timing such that the delay described above is not generated. Further, the clock CLK1 itself may be varied with the frequency spreader. Further, in the embodiments described above, the process is executed with a cycle of Fetch (IF), Decode (ID), Execute (EX), Data Cache (DC) and Write Back (WB); however, the process may be executed differently. In particular, the process immediately after Execute (EX) is arbitrary. Further, Data Cache (DC) and Write Back (WB) may correspond to the process of writing the operation result of Execute (EX) in the memory, the register file or the like. Further, Data Cache (DC) may be referred to as Memory Access (MA or MEM), and thus naming may be arbitrary.

Further, in the embodiments described above, as preferred embodiments, the minimum set computing unit 11, which includes the minimum gates (or elements) which are capable of configuring possibly all computing elements corresponding to all the instruction sets, is used as a dynamically configurable computing unit; however, instead of the minimum set computing unit 11, the dynamically configurable computing unit which has more gate(s) or element(s) than the minimum set computing unit 11 may be used (see FIG. 12), or the dynamically configurable computing unit which has less gate(s) or element(s) than the minimum set computing unit 11 may be used.

1. A dynamically reconfigurable processor which executes a series of processes on an instruction basis for respective instructions, comprising:
a dynamically configurable computing unit which dynamically configures a computing element according to the instruction; and
a clock generating circuit configured to generate a main clock and a sub-clock which is different from the main clock, wherein
start timing for the processes in the series of processes is determined based on the main clock except for an instruction execution process of executing the instruction with the dynamically configurable computing unit,
the instruction execution process of executing the instruction with the dynamically configurable computing unit includes a computing element generating sub-process of dynamically configuring, with the dynamically configurable computing unit, the computing element corresponding to the instruction, and an operation sub-process of performing an operation according to the instruction with the computing element configured in the computing element generating sub-process,
start timing for the computing element generating sub-process and the operation sub-process is determined based on the sub-clock,
the sub-clock is generated such that the computing element generating sub-process and the operation sub-process are completed before the start timing for a process which is to be executed immediately after the instruction execution process, and
the dynamically configurable computing unit consists of a minimum set computing unit which includes minimum gates or elements which are capable of configuring possibly all the computing elements which may be generated in the computing element generating sub-process.

2. The dynamically reconfigurable processor of claim 1, wherein the start timing for the process which is to be executed immediately after the instruction execution process is set such that it is delayed by two clock periods of the main clock with respect to start timing for a process which is to be executed immediately before the instruction execution process.

3. The dynamically reconfigurable processor of claim 1, wherein the sub-clock is a multiplied clock of the main clock, a phase-shifted clock of the main clock, or a phase-shifted and multiplied clock of the main clock.

4. (canceled)

5. The dynamically reconfigurable processor of claim 1, wherein
a single-threaded operation is performed using the minimum set computing unit.

6. The dynamically reconfigurable processor of claim 1, comprising plural of the dynamically configurable computing units, and
a parallel process or a pipeline process is performed using the respective dynamically configurable computing units.

7. The dynamically reconfigurable processor of claim 1, further comprising: a non-reconfigurable computing unit, wherein
the dynamically configurable computing unit and the non-reconfigurable computing unit are selectively used according to the instruction, and
start timing for the instruction execution process in which the instruction is executed using the non-reconfigurable computing unit is determined based the main clock.

8. The dynamically reconfigurable processor of claim 7, wherein the non-reconfigurable computing unit is used for a predetermined instruction which is generated at a relatively high frequency, and the dynamically configurable computing unit is used for a predetermined instruction which is generated at a relatively low frequency.

9. The dynamically reconfigurable processor of claim 7, wherein if the same instructions are issued simultaneously and the number of the instructions is greater than the number of the non-reconfigurable computing units, the non-reconfigurable computing units are used for the instructions whose number is equal to the number of the non-reconfigurable computing units, and the dynamically configurable computing unit is used for the remaining instruction.

10. The dynamically reconfigurable processor of claim 1, wherein
the dynamically reconfigurable processor further comprises a backup gate or element which is to be used if the gate or the element of the minimum set computing unit fails.

11. The dynamically reconfigurable processor of claim 1, wherein the dynamically configurable computing unit consists of a minimum set computing unit which includes minimum gates which are capable of configuring possibly all the computing elements which may be generated in the computing element generating sub-process, units of the gates being NAND, NOR and NOT, and
the computing element generating sub-process includes connecting the gates to dynamically configure the computing element corresponding to the instruction, the units of the gates being NAND, NOR and NOT.

12. The dynamically reconfigurable processor of claim 1, wherein the dynamically configurable computing unit consists of a minimum set computing unit which includes minimum elements which are capable of configuring possibly all the computing elements which may be generated in the computing element generating sub-process, units of the elements being at a level of a PchMOSFET and a NchMOSFET, and
the computing element generating sub-process includes connecting the elements to dynamically configure the computing element corresponding to the instruction, the units of the elements being at a level of a PchMOSFET and a NchMOSFET.

13. A method of operating a processor, comprising:
a fetch process of retrieving an instruction;
a decode process of decoding the retrieved instruction;
an execute process; and
a data cache process, wherein
the execute process includes a computing element generating sub-process of dynamically configuring a computing element corresponding to the instruction with a minimum set computing unit which includes minimum gates or elements which are capable of configuring possibly all the computing elements which may be generated in the computing element generating sub-process, and an operation sub-process of performing an operation according to the instruction with the computing element configured in the computing element generating sub-process,
the fetch process is performed at a first timing which is determined by a main clock,
the decode process is performed at a second timing which is determined by the main clock,
the computing element generating sub-process is performed at the first timing which is determined by a sub-clock, instead of a third timing which is determined by the main clock, and the operation sub-process is performed at the second timing which is determined by the sub-clock, and
the data cache process is performed at a fourth timing which is determined by the main clock.
